(19) United States
(12) Patent Application Publication
(10) Pub. No.: US 2010/0218137 A1
(43) Pub. Date: Aug. 26, 2010

(54) CONTROLLING METHOD FOR ELECTRONIC DEVICE

(75) Inventors: Mong-Yong Sim, Taipei City (TW); Cheng-En Wu, Taipei City (TW); Jung-Chen Hung, Taipei City (TW); Ying Leelin, Taipei County (TW)

Correspondence Address: COVENANT IP CONSULTING CO., P.O. BOX 34-306 TAIPEI CITY, TAIPEI, 10499, TW

(73) Assignee: QISDA CORPORATION, Taoyuan Shien (TW)

(21) Appl. No.: 12/692,651

(22) Filed: Jan. 25, 2010

(30) Foreign Application Priority Data
Feb. 26, 2009 (TW) 98106253

(51) Int. Cl. G06F 3/048; G06F 3/033

(52) U.S. Cl. 715/788; 715/863

(57) ABSTRACT

A controlling method for an electronic device having a screen is provided. A first GUI element is displayed on the screen. An operation distance and an operation time between a first object and a second object above the screen corresponding to the first GUI element are detected. Operation functions are selectively performed to the first GUI element by the electronic device according to the operation distance and the operation.

This application claims the benefit of Taiwan application Serial No. 98106253, filed Feb. 26, 2009, the subject matter of which is incorporated herein by reference.

### BACKGROUND OF THE INVENTION

1. Field of the Invention

The invention relates in general to a controlling method for an electronic device, and more particularly to a controlling method for an electronic device providing the user with greater convenience in operation.

2. Description of the Related Art

Various electronic devices are now aimed at providing high convenience in operation. Particularly, the design, which dispenses with the use of operational buttons and controls the electronic device by way of sensing screen or touch screen, has become an important direction to the manufacturers in terms of cost saving by way of reducing the size of the electronic device and saving part of the elements.

### SUMMARY OF THE INVENTION

The invention is directed to a controlling method for an electronic device. The electronic device detects relations between the bodies above the screen and the GUI (graphical user interface) elements and further performs corresponding functions according to the detected relations for providing the user with greater convenience in operation.

According to a first aspect of the present invention, a controlling method for an electronic device is provided. The electronic device has a screen. The controlling method includes the following steps. A first GUI element is displayed on the screen. An operation distance and an operation time between a first object and a second object above the screen corresponding to the first GUI element are detected. Operation functions are selectively performed to the first GUI element by the electronic device according to the operation distance and the operation time.

According to a second aspect of the present invention, a controlling method for an electronic device is provided. The electronic device has a screen. The controlling method includes the following steps. Multiple GUI elements are displayed on the screen. Relations between a first object and a second object above the screen and the GUI elements are detected. Corresponding functions are selectively performed to the GUI elements by the electronic device according to the detected relations.

According to a third aspect of the present invention, a controlling method for an electronic device is provided. The electronic device has a screen used for displaying multiple GUI elements with consecutive numbers. The controlling method includes the following steps. A first GUI element with a first number is displayed on the screen at a first size. A second GUI element with a second number is displayed in a pre-viewing area ata a second size overlapping the first GUI element by the electronic device. The first size is larger than the second size.

The invention will become apparent from the following detailed description of the preferred but non-limiting embodiments. The following description is made with reference to the accompanying drawings.

### BRIEF DESCRIPTION OF THE DRAWINGS

FIG. 1 show a first flowchart of a controlling method for an electronic device of the invention;

FIG. 2A, FIG. 2B and FIG. 2C show an electronic device according to a first embodiment of the invention;

FIG. 3A and FIG. 3B show an electronic device according to a second embodiment of the invention;

FIG. 4A, FIG. 4B and FIG. 4C show an electronic device according to a third embodiment of the invention;

FIG. 5A and FIG. 5B show an electronic device according to a fourth embodiment of the invention;

FIG. 6 show a second flowchart of a controlling method for an electronic device of the invention;

FIG. 7A and FIG. 7B show an electronic device according to a fifth embodiment of the invention;

FIG. 8A, FIG. 8B and FIG. 8C show an electronic device according to a sixth embodiment of the invention; and

FIG. 9A and FIG. 9B show an electronic device according to a seventh embodiment of the invention.

### DETAILED DESCRIPTION OF THE INVENTION

The invention provides a controlling method for an electronic device. The electronic device detects relations between the bodies above the screen and the GUI elements displayed on the screen and further performs corresponding functions according to the relations so as to provide the user with convenience in operation.

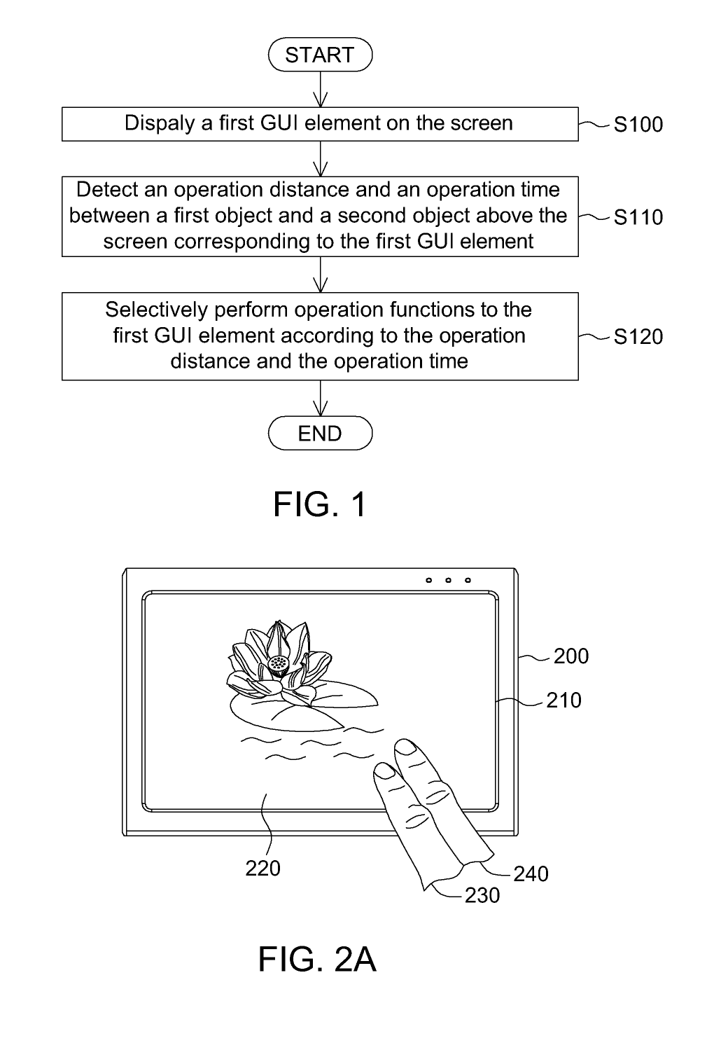

The invention provides an controlling method for an electronic device. The electronic device has a screen. Referring to FIG. 1, a first flowchart of a controlling method for an electronic device of the invention is shown. In step S100, a first GUI element is displayed on the screen. In step S110, an operation distance and an operation time between a first object and a second object above the screen corresponding to the first GUI element are detected by the electronic device. In step S120, operation functions are selectively performed to the first GUI element by the electronic device according to the operation distance and the operation time.

### First Embodiment: Turning Over Page by Pulling

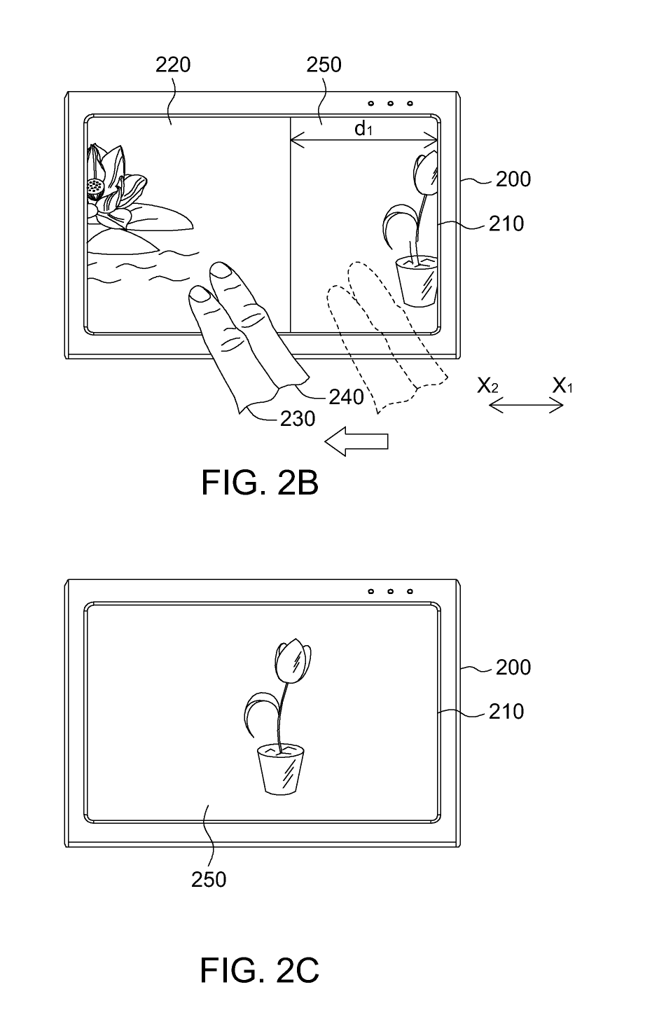

Referring to FIG. 2A, FIG. 2B and FIG. 2C, an electronic device according to a first embodiment of the invention is shown. In FIG. 2A, the electronic device 200 has a screen 210, on which the first GUI element 220 is displayed in full-screen mode, wherein the first GUI element 220, such as an executing program, is a full-screen picture or window. The electronic device 200 detects relations between a first object and a second object above the screen 210 and the first GUI element 220, and further performs corresponding functions according to the relations. In the invention, the object detected on the screen can be the user's finger, stylus or other object that can be used for performing input control on the screen, and is not subjected to further restriction. Besides, the screen 210 can be a touch screen or a detector equipped with ultra-red, sonar or heat sensor for detecting the position of the GUI element on the screen. The electronic device is equipped with elements such as central control unit and memory. This is known to anyone skilled with the technology of the invention and is not repeated here.

In FIG. 2B, if the electronic device 200 detects that the user's corresponding fingers 230 and 240 touch the screen 210 and simultaneously pulled in the first direction x₁, the first GUI element 220 is moved in the first direction x₁ with respect to the fingers 230 and 240, and the second GUI element 250 is jointed to an edge of the first GUI element 220 and is moved and displayed on the screen 210. The second GUI element 250 can be a background execution program. If the movement distance (or operation distance) d₁ of the first GUI element 220 exceeds a first default distance PD₁, the first GUI element 220 continues to move in the first direction x₁ and vanish from the screen 210 at the average speed of pulling or the speed of final movement. As indicated in FIG. 2C, the second GUI element 250 is jointed to the first GUI element 220 and is displayed on the screen 210 in full-screen mode. In the present embodiment, the first GUI element 220 and the second GUI element 250 can be two consecutive pages of an electronic book or the file of two image files during browsing.

If the movement distance d₁ of the first GUI element 220 pulled by the fingers 230 and 240 is less than the first default distance PD₁ and the electronic device 200 cannot detect the fingers 230 and 240, then the first GUI element 220 moves in a direction x₂ opposite to the first direction x₁ and the second GUI element 50 vanishes from screen 210, the first GUI element 220 is displayed on the screen 210 in full-screen mode as indicated in FIG. 2A.

### Second Embodiment: Enlarging a Selection Area

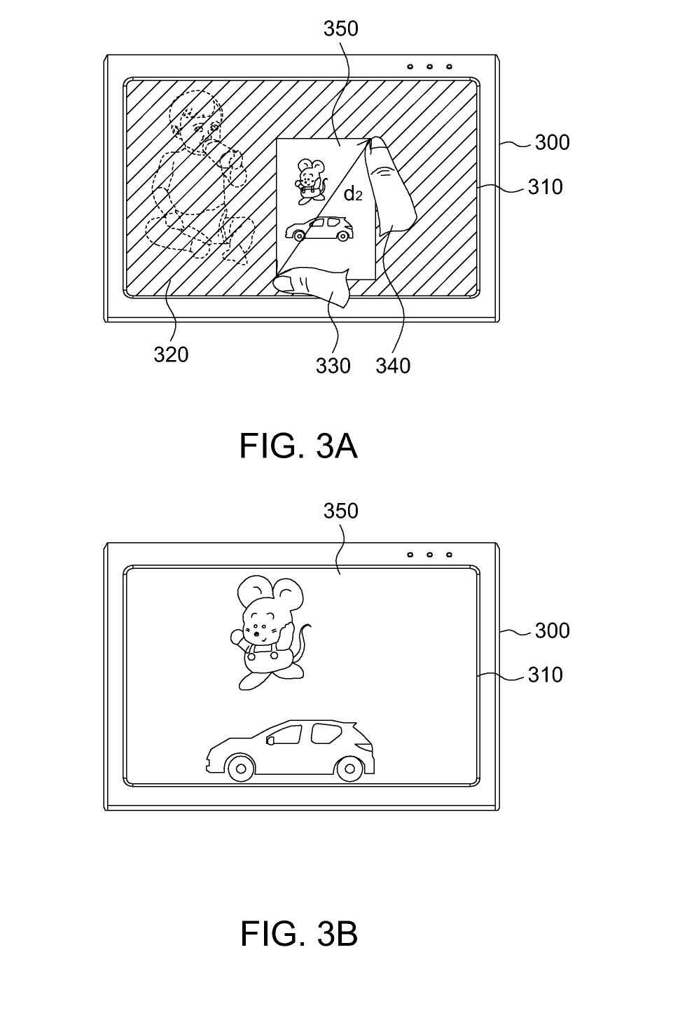

Referring to FIG. 3A and FIG. 3B, an electronic device according to a second embodiment of the invention is shown. In FIG. 3A, the electronic device 300 displays the first GUI element 320 (such as picture browsing) on the screen 310. In FIG. 3A, if the electronic device 300 detects that the relative distance (or operation distance) d₂ of the finger 330340 above the first GUI element 320 exceeds a second default distance PD₂, then the electronic device 300 displays a rectangular selection area 350 on the first GUI element 320. The fingers 330 and 340 correspond to two diagonal end-points of the rectangular selection area 350. The size of the rectangular selection area 350 and the rectangular pattern will change along with the change in the relative position to which the fingers 330 and 340 point. The rectangular selection area 350 can be denoted by a squared frame, the part within the rectangular selection area 350 has the first brightness and the part outside the rectangular selection area 350 has the second brightness. The first brightness can be higher than the second brightness so that user can distinguish the difference.

When the rectangular selection area 350 is confirmed and the electronic device 200 detects that the fingers 330 and 340 leave the top the first GUI element 320, then the screen 310 displays an enlarged rectangular selection area 350. The screen 310 can enlarge the rectangular selection area 350 to be as large as the screen 310 can display. As indicated in FIG. 3B, the rectangular selection area 350 is enlarged in a full-screen mode and at least one edge of the rectangular selection area 350 is enlarged to be the same with one edge of the screen 310.

### Third Embodiment: Zooming and Command Displaying

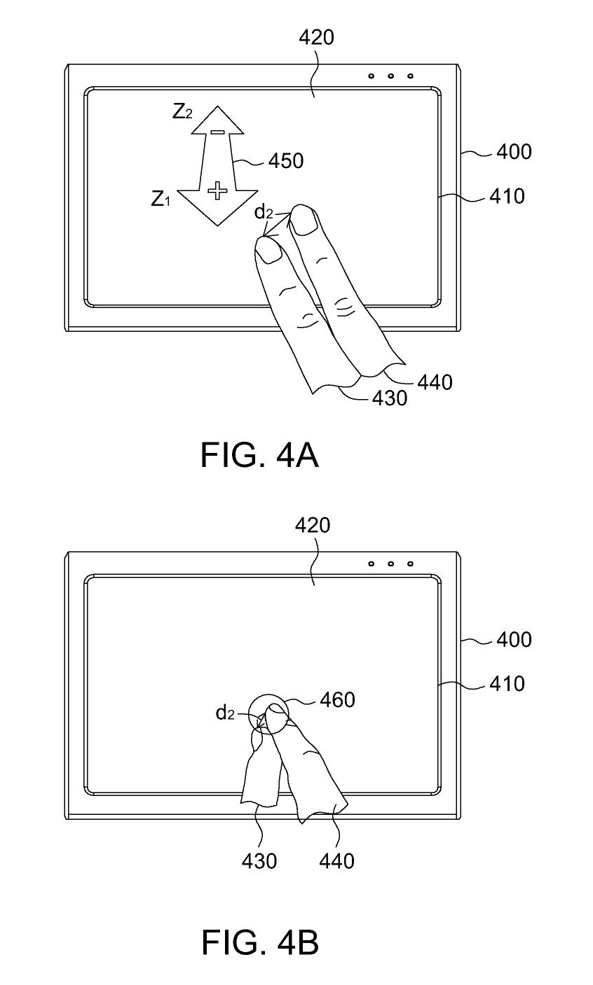

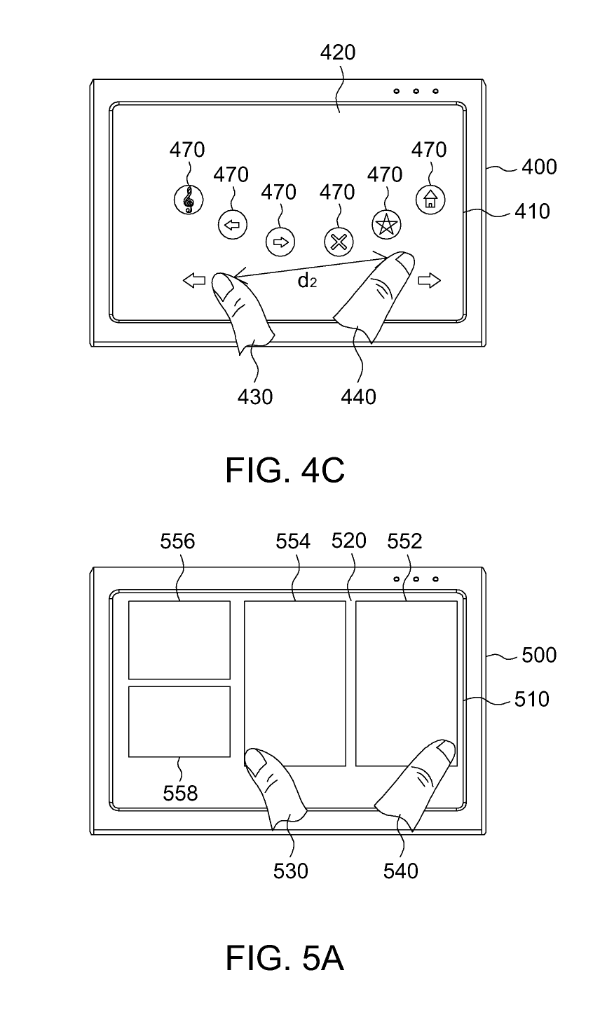

Referring to FIG. 4A˜4C, an electronic device according to a third embodiment of the invention is shown. In FIG. 4A, if the electronic device 400 detects that the fingers 430 and 440 simultaneously point to the first GUI element 420 and do not exceed a predetermined time (or an operation time) PT, and the relative distance (or operation distance) d₂ of the fingers 430 and 440 above the first GUI element 420 does not exceed a second default distance PD₂, then the electronic device 400 [symbol] selectively zooms in or zooms out the first GUI element 420 when the electronic device 400 detects the fingers 430 and 440 simultaneously.

If the electronic device 400 detects that the fingers 430 and 440 simultaneously move in the second direction z₁, then the electronic device 400 performs zoom-in function to the first GUI element 420. If the electronic device 400 detects that the fingers 430 and 440 simultaneously move in the third direction z₂, then the electronic device 400 performs zoom-out function to the first GUI element 420. The third direction z₂ is opposite to the second direction z₁. In the present embodiment, the second direction z₁ points to the top of the screen 410, and the third direction z₂ points to the underneath of the screen 410. Besides, the electronic device 400 can display a zooming command icon 450 on the screen 410 for displaying the second direction z₁ and the third direction z₂ so that the user can easily recognize which direction to zoom in or zoom out.

When the electronic device 400 detects that the fingers 430 and 440 simultaneously point to the first GUI element 420 over a predetermined time PT, and the relative distance d₂ of the fingers 430 and 440 above the first GUI element 420 does not exceed the second default distance PD₂, then, as indicated in FIG. 4B, the electronic device 400 displays a command icon 460 within the first GUI element 420. If the electronic device 400 detects the fingers 430 and 440 move relatively above the first GUI element 420 and the relative distance d₂ exceeds a third default distance PD₃, then, as indicated in FIG. 4C, the electronic device 400 augments the command icon 460 into a plurality of functional icons 470 for the user to select and perform the needed function. The functional icons 470 can be the corresponding commands of the first GUI element 420. For example, when the first GUI element 420 is a text compiling window, the functional icons 470 can be the commands such as “copy”, “clip”, “paste”, and so on. If the first GUI element 420 is a browser window, the functional icons 470 can be the commands such as “previous page”, “next page”, “insert bookmark” and so on.

### Fourth Embodiment: Element Selection, Copy

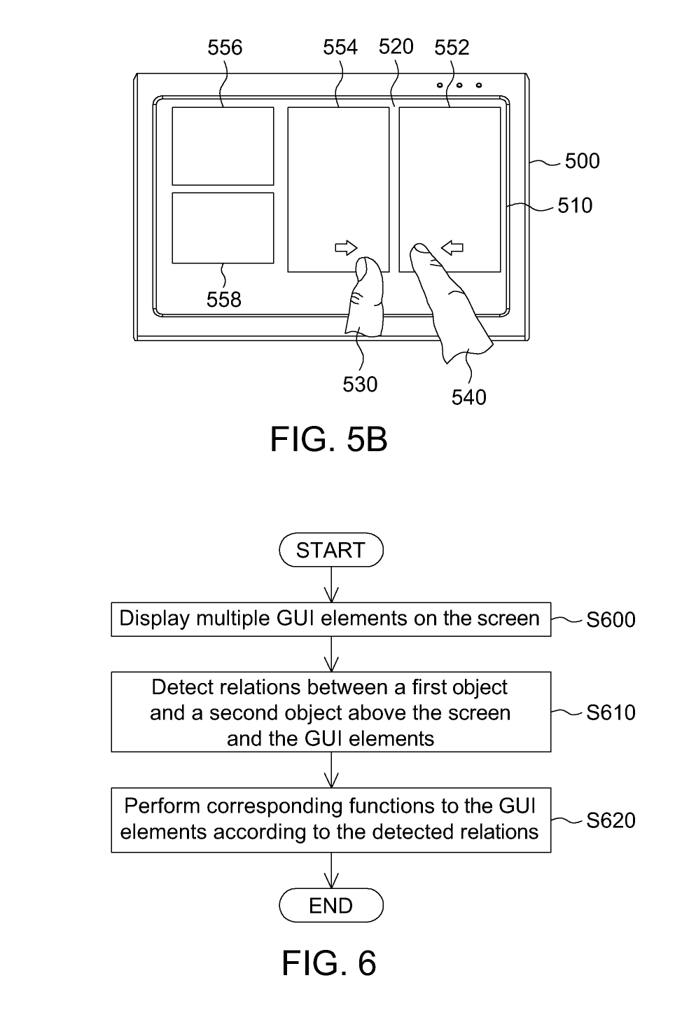

Referring to FIG. 5A and FIG. 5B, an electronic device according to a fourth embodiment of the invention is shown. The electronic device 500 has a screen 510. In FIG. 5A, the electronic device 500 displays a first GUI element 520 on the screen 510. The electronic device 500 detects relations between the fingers 530 and 540 above the screen 510 and the first GUI element 520, and further performs corresponding functions according to the detected relations. Besides, the finger 530 and 540 can control the electronic device 500 by touching the screen 510 such as a touch screen for example.

The first GUI element 520 includes a plurality of modules, such as modules 552˜558 for example. The electronic device 500 detects whether the modules 552˜558 are pointed by the fingers 530 or 540, and further selects the pointed module. In FIG. 5A, the module 552 is pointed by the finger 540 and the module 554 is pointed by the finger 530, then the electronic device 500 will select the module 552 and 554. Afterwards, as indicated in FIG. 5B, if the electronic device 500 detects that the finger 530 and the finger 540 simultaneously point to the first GUI element 520, and the positions pointed by the finger 530 and the finger 540 are moved towards each other, then the electronic device 500 copies the previously selected modules 552 and 554.

The invention further provides a controlling method for an electronic device. The electronic device has a screen. Referring to FIG. 6, a second flowchart of an controlling method for an electronic device of the invention is shown. In step S600, multiple GUI elements are displayed on the screen. In step S610, relations between a first object and a second object above the screen and the GUI elements are detected by the electronic device. In step S620, corresponding functions are performed to the GUI elements according to the detected relations.

### Fifth Embodiment: Screen Unlocking

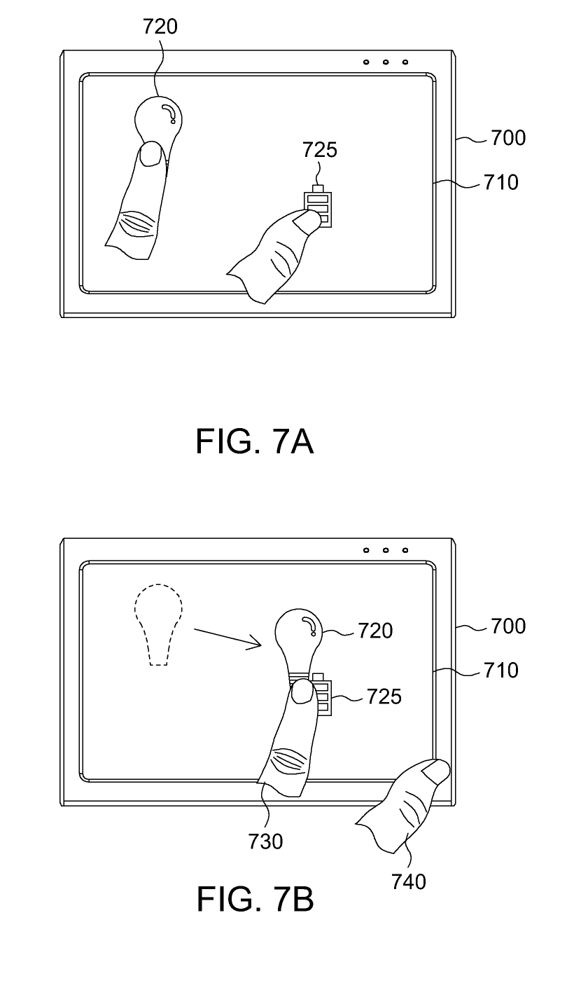

Referring to FIG. 7A and FIG. 7B, an electronic device according to a fifth embodiment of the invention is shown. The electronic device 700 has a screen 710. The electronic device 700 displays a first GUI element 720 and a second GUI element 725 on the screen 710. The first GUI element 720 and the second GUI element 725 can be displayed on the screen 710 in stillness or in motion.

As indicated in FIG. 7A, if the finger 730 points to the first GUI element 720 and simultaneously the finger 740 points to the second GUI element 725, then the electronic device 700 performs a default command. As indicated in FIG. 7B, if the finger 730 points to the first GUI element 720 and pulls the first GUI element 720 to the second GUI element 725 so that the finger 730 simultaneously point to the first GUI element 720 and the second GUI element 725, then the electronic device 700 performs a default command. In the present embodiment of the invention, if the screen 710 is in a locking state, then the default command is a screen unlocking command corresponding to the locking state.

### Sixth Embodiment: Rearrangement of Elements Inside a Window

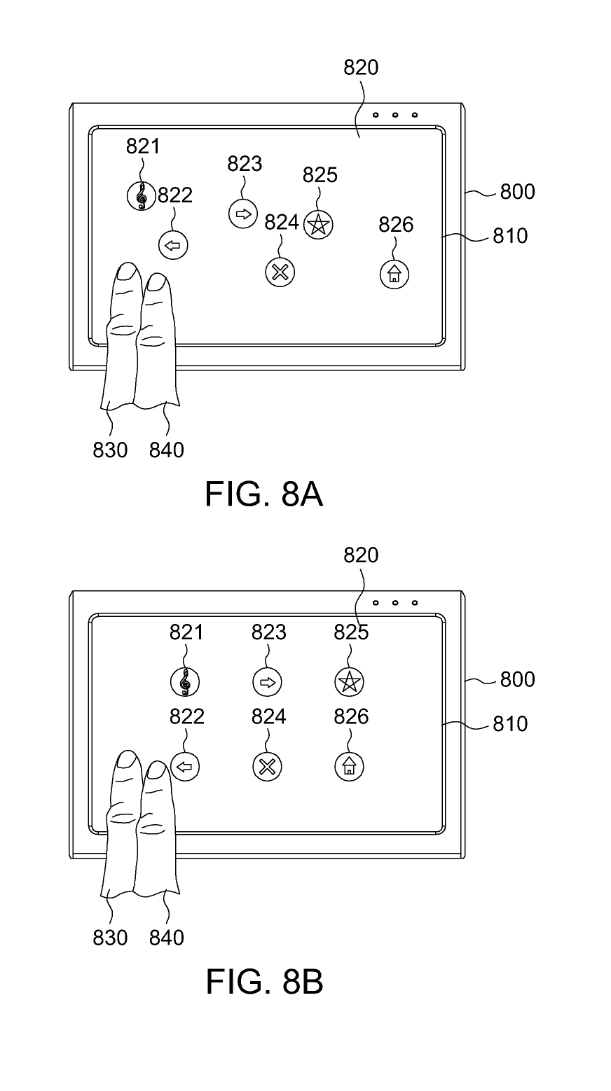

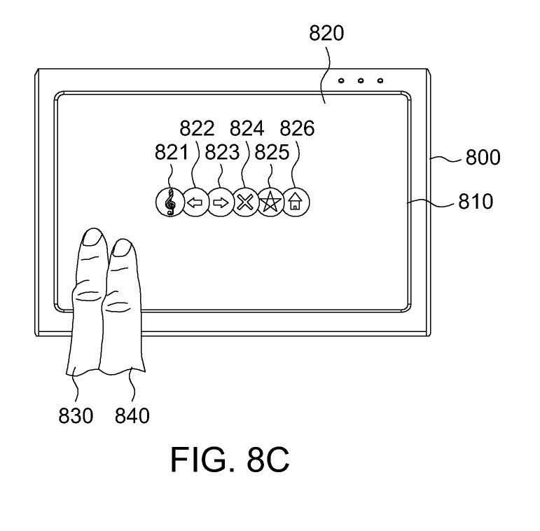

Referring to FIG. 8A, FIG. 8B and FIG. 8C, an electronic device according to a sixth embodiment of the invention. The electronic device 800 has a screen 810. The electronic device 800 displays a plurality of GUI elements, such as icons 820˜825, on the screen 810. If the electronic device 800 detects that the fingers 830 and 840 simultaneously double-click the screen 810 at the area other than the icons 820˜82, then the electronic device 800 displays the icons 820˜825 on the screen 810 in the order of a plurality of arrangement modes.

As indicated in FIG. 8A, the fingers 830 and 840 double-click the screen 810 at the non-icon area, then, under the user arrangement mode, the user can arrange the icons 821˜826 on the screen 810 by with the finger 830. The user arrangement mode, after being used by the user, is saved to the electronic device. As indicated in FIG. 8B, the fingers 830 and 840 again double-click the screen 810 at the non-icon area, then under a lattice arrangement mode, the icons 821˜826 are displayed on the screen 810 in a lattice. As indicated in FIG. 8C, the fingers 830 and 840 again double-click the screen 810 at the non-icon area, then the icons 821˜826, then under a bar arrangement mode, the icons 821˜826 are displayed on the screen 810 in a bar. As indicated in FIG. 8C, the neighboring icons 821˜826 can be partly overlapped one another or the icons 821˜826 can be arranged in a bar without overlapping one another. In the present embodiment of the invention, the icons 821˜826 are located within the full-screen window 820. The invention is also applicable to a window 820 not displaying a full screen.

### Seventh Embodiment: Turning Over the Pages of an Electronic Book

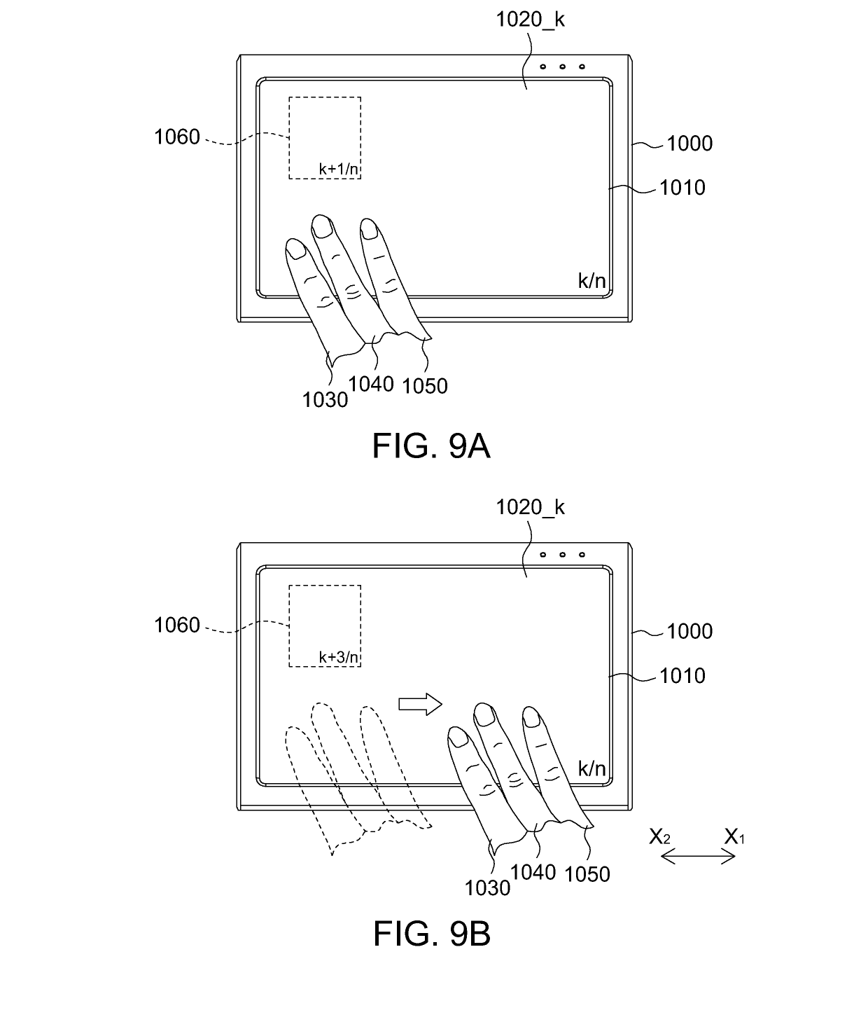

Referring to FIG. 9A and FIG. 9B, an electronic device according to a seventh embodiment of the invention is shown. The electronic device 1000 has a screen 1010 for displaying a first sized GUI element 1020. The GUI element includes a plurality of sub-GUI elements with consecutive numbers such as sub-GUI element 1020_1˜1020_{—}n. Examples of the GUI element include an electronic book, a word file or a PDF file.

The programs performed by the electronic device 1000 indicated in FIG. 9A and 9B can sequentially n sub-GUI elements 1020_2, 1020_3, . . . , and 1020_{—}n with consecutive numbers on the screen 1010, wherein the n sub-GUI elements can be an electronic book. As indicated in FIG. 9A, the screen 1010 displays a sub-GUI element 1020_{—}k with a k-th number (such as the k-th page of an electronic book). If the electronic device 1000 detects that the fingers 1030, 1040 and 1050 in the space simultaneously point to the sub-GUI element 1020_{—}k, then the sub-GUI element 1020_{—}k+1 (such as the (k+1)-th page of an electronic book) will be displayed on a second sized pre-viewing area 1060 of the screen 1010, wherein the first size is larger than the second size. As indicated in FIG. 9B, if the positions to which the fingers 1030, 1040 and 1050 point are pulled to move in the first direction x₁, then the pages of the electronic book displayed in the pre-viewing area 1060 according to increasing page numbers, such as the (k+2)-th page, the (k+3)-th page. The larger the movement, the faster the page switching rate in the pre-viewing area 1060. That is, the movement is proportional to the page switching rate. Also, if the positions to which the fingers 1030, 1040 and 1050 point are moved in the direction x₂ opposite to the first direction x₁, then the pages of the electronic book are switched in the pre-viewing area 1060 according to decreasing page number, meanwhile, there is a relation between the size of movement and the switching rate. When the fingers 1030, 1040 and 1050 leave the top of the screen, the screen 1010 simultaneously displays the page in the pre-viewing area 1060.

The controlling method for an electronic device disclosed in the above embodiments of the invention has many advantages exemplified below:

According to the controlling method for an electronic device disclosed in the invention, the electronic device detects multiple objects above the screen, one or multiple relations between GUI elements are displayed on the screen, and corresponding functions are performed according to the detected results so as to provide the user with superior convenience in operation.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A controlling method for an electronic device having a screen, the controlling method comprising:
displaying a first GUI element on the screen;
detecting an operation distance and an operation time between a first object and a second object above the screen corresponding to the first GUI element; and
selectively performing operation functions to the first GUI element by the electronic device according to the operation distance and the operation time.

2. The controlling method according to claim 1, further comprising:
displaying the first GUI element on the screen in a full-screen mode; and
pulling the first GUI element for the operation distance toward a first direction on the screen by the first object and the second object;
pulling and displaying a second GUI element on the screen when the first object and the second object moving toward the first direction of the screen simultaneously, wherein the second GUI element is jointed to an edge of the first GUI element;
continuingly moving the first GUI element in the first direction until the first GUI element vanishes from the screen if the operation distance exceeds a first default distance; and
displaying the second GUI element on the screen in the full-screen mode.

3. The controlling method according to claim 2, wherein if the operation distance is less than the first default distance and the electronic device does not detect the first object and the second object above the screen, the first GUI element moves in a direction opposite to the first direction and the second GUI element vanishes from the screen.

4. The controlling method according to claim 1, further comprising:
displaying a rectangular selection area on the first GUI element when the electronic device detecting the operation distance between the first object and the second object above the screen exceeds a second default distance, wherein the first object and the second object correspond to two diagonal end-points of the rectangular selection area.

5. The controlling method according to claim 4, wherein when the first object and the second object are not above the screen, the screen enlarges and displays the rectangular selection area.

6. The controlling method according to claim 4, wherein a portion of the first GUI element being out of the rectangular selection area has a second brightness, and the rectangular selection area has a first brightness higher than the second brightness.

7. The controlling method according to claim 1, further comprising:
selectively performing a zoom-in function and a zoom-out function for the first GUI element by the electronic device when the first object and the second object move simultaneously and are simultaneously pointed to the first GUI element for the operation time not exceeding a first default time and the operation distance between the first object and the second object above the first GUI element not exceeding a second default distance.

8. The controlling method according to claim 7, further comprising:
performing the zoom-in function to the first GUI element by the electronic device when it is detected that the first object and the second object simultaneously move towards a second direction; and
performing the zoom-out function to the first GUI element by the electronic device when it is detected that the first object and the second object simultaneously move towards a third direction, wherein the third direction is opposite to the second direction.

9. The controlling method according to claim 1, further comprising:
displaying a command icon in the first GUI element by the electronic device when it is detected that the first object and the second object are simultaneously pointed to the first GUI element for the operation time exceeding a second default time and the operation distance between the first object and the second object above the first GUI element less than a second default distance.

10. The controlling method according to claim 9, further comprising:
expanding the command icon into a plurality of functional icons by the electronic device when the relative distance between the first object and the second object above the first GUI element exceeds a third default distance.

11. The controlling method according to claim 1, wherein the screen is a touch screen, and the first object and the second object control the electronic device by contacting the touch screen.

12. A controlling method for an electronic device having a screen, the controlling method comprising:
displaying a plurality of GUI elements on the screen; and
detecting the relations between a first object and a second object above the screen and the GUI elements, and performing corresponding functions to the GUI elements by the electronic device according to the detected relations.

13. The controlling method according to claim 12, the GUI elements comprises a first GUI element and a second GUI element, the controlling method comprising:
detecting whether the first object and the second object are simultaneously pointed to the first GUI element and the second GUI element ; and
performing a screen unlocking command by the electronic device when the screen is in a locking state.

14. The controlling method according to claim 13, the controlling method comprising:
pulling the first GUI element by the first object;
performing a screen unlocking command when the first GUI element connecting to the second GUI element.

15. The controlling method according to claim 12, the GUI elements comprising a plurality of icons, the method comprising:
displaying the icons on the screen by one of a plurality of arrangement modes; and
sequentially switching the arrangement modes for displaying the icons when the electronic device detecting the first object and the second object simultaneously double-click the screen except the icons.

16. The controlling method according to claim 15, the arrangement modes comprising a user arrangement mode, wherein positions of the icons in the user arrangement mode are the positions the user sets.

17. The controlling method according to claim 15, the arrangement modes comprising a lattice arrangement mode, wherein the icons are arranged in a lattice in the lattice arrangement mode.

18. The controlling method according to claim 15, the arrangement modes comprising a bar arrangement mode, wherein the icons are arranged in a bar in the bar arrangement mode.

19. A controlling method for an electronic device, having a screen used for displaying a plurality of GUI elements with consecutive numbers, the controlling method comprising:
displaying a first GUI element with a first number at a first size on the screen; and
displaying a second GUI element with a second number in a pre-viewing area at a second size overlapping the first GUI element by the electronic device, wherein the first size is larger than the second size.

20. The controlling method according to claim 19, further comprising:
displaying the pre-viewing area when the electronic device detects a first object, a second object and a third object are simultaneously pointed to the first GUI element and moves in a first direction;
displaying the GUI elements in the pre-viewing area with increasing page numbers when the first object, the second object and the third object are simultaneously moved for a first movement in the first direction, wherein the size of the first movement is proportional to the page switching rate in the pre-viewing area.

21. The controlling method according to claim 20, further comprising:
displaying the GUI elements in the pre-viewing area according to decreasing page number when it is detected that the first object, the second object and the third object are simultaneously moved in a second direction, wherein the second direction is opposite to the first direction.
